(19) United States
(12) Patent Application Publication
(10) Pub. No.: US 2004/0133464 A1
(43) Pub. Date: Jul. 8, 2004

(54) Parking system using wireless enforcement terminals and real time occupancy data

(76) Inventor: Neil S. Erskine, Halifax (CA)

Correspondence Address: Norman P. Soloway, HAYES SOLOWAY P.C., 130 W. Cushing Street, Tucson, AZ, 85701, US

(21) Appl. No.: 10/675,484

(22) Filed: Sep. 30, 2003

Related U.S. Application Data
(60) Provisional application No. 60/428,693, filed on Nov. 25, 2002.

(51) Int. Cl. G06F 17/60

(52) U.S. Cl. 705/13

(57) ABSTRACT

In a parking system having one or more payment terminals for receiving payment for parking spaces, an information processing centre for receiving transaction and alarm information from the payment terminals, one or more enforcement terminals and a two-way telecommunications network for transmitting information in real time between the information processing centre and the payment and the enforcement terminals, an enforcement system and a method where a minimal amount of data is sent to enforcement terminals while in use in the field. The enforcement terminals are preloaded with parking space graphics. Occupancy data, which includes only the data necessary to provide expiry information such as, for instance, a data bit for each space indicating if it is “paid” or if it is “expired”, is transmitted in real time to the enforcement terminal. The occupancy data may be transmitted periodically or on demand by the enforcement terminal. In this approach, significant data packet network costs can be saved as the network costs are usually based on volume of data flow.

### CROSS-REFERENCE TO RELATED APPLICATION

This application claims the benefit of U.S. Provisional Patent Application Serial No. 60/428,693 filed on Nov. 25, 2002.

### FIELD OF THE INVENTION

The invention relates generally to parking meter systems and more particularly to enforcement for parking meter systems using a pay by space concept.

### BACKGROUND OF THE INVENTION

In order to enforce the parking regulations, it is necessary to continuously provide enforcement officers with up to date information regarding the “paid” and “expired” parking spaces. The space information can be in the form of an updated list, or graphical images overlaid with space status. The graphics or updated list for the street or parking lot map and parking space status is therefore updated on a regular basis on the enforcement terminals carried by the enforcement staff to get a clear and accurate picture of what parking spaces are expired. With this approach, where the graphical representation of the parking spaces or a full detailed space listing and their availability is repeatedly transmitted, data volumes and hence wireless network costs can be very high.

Therefore, there is a need for a system and a process that will reduce the cost of enforcement.

### BRIEF SUMMARY OF THE INVENTION

It is an object of the invention to provide an improved Parking Enforcement System Using Wireless Enforcement Terminals And Real Time Space Occupancy Data.

The invention is directed to a system and a method where the minimal amount of data that is necessary is sent to enforcement terminals while in use in the field. The enforcement terminals are preloaded with parking space graphics or a full detailed space list, and the transmitted data includes only the minimum data necessary to provide expiry information such as, for instance, a data bit for each space indicating if it is “paid” or if it is “expired”. In this approach, significant data packet network costs can be saved as the network costs are usually based on volume of data flow.

In accordance with one aspect of this invention, a parking system comprises one or more payment terminals for receiving payment for parking spaces, an information processing centre for receiving transaction and alarm information from the payment terminals, one or more enforcement terminals for storing identification information for selected parking spaces and for periodically receiving occupancy data for the selected parking spaces from the information processing centre and a two-way telecommunications network for transmitting information in real time between the information processing centre and the payment and the enforcement terminals wherein the enforcement terminal displays a map of the parking spaces with an occupancy indication for each space.

In accordance with another aspect of this invention, a parking enforcement system for a parking system having one or more payment terminals for receiving payment for parking spaces comprises an enforcement server for receiving transaction information from the payment terminals and for generating occupancy data for the parking spaces in real time, and one or more enforcement terminals for storing identification information for selected parking spaces and for receiving occupancy data for the selected parking spaces from the enforcement server for displaying a map of the parking spaces with an indication of occupancy.

In accordance with specific aspects of this invention, the enforcement terminals include means for displaying the identification information for the parking spaces as graphic information, which may include the street location of the parking spaces and parking space location numbers. The street location information may include street name, connecting streets and landmarks. The parking space occupancy data, which depicts whether the parking space is “paid” or “expired”, is overlaid on the parking space location numbers to indicate occupancy.

With regard to a further aspect of the invention, the enforcement terminal receives the occupancy data on demand or periodically.

In accordance with a further aspect of this invention, a method of enforcing a parking system having one or more payment terminals for parking spaces and one or more enforcement terminals comprises storing identification information of selected parking spaces in the enforcement terminals, receiving transaction information from the payment terminals, processing the transaction information to provide parking space occupancy data, transferring real time space occupancy data regarding the selected parking spaces to the enforcement terminals, and displaying the selected parking space information and the occupancy data on the enforcement terminal to provide an indication whether each selected parking space is “paid” or “expired”.

In accordance with a specific aspect of this invention, the space occupancy data regarding the selected parking spaces may be transferred to the enforcement terminals periodically or when requested by the enforcement terminal.

In accordance with a specific aspect of this invention, the space occupancy data regarding the selected parking spaces may be transferred to the enforcement terminals periodically or when requested by the enforcement terminal.

With regard to another aspect of the invention, the method may further include receiving alarm information from the payment terminals and processing the alarm information to manage the parking system

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF SEVERAL VIEWS OF THE DRAWINGS

These and other features of the invention will become more apparent from the following description in which reference is made to the appended drawings wherein:

FIG. 1 illustrates a parking system in accordance with the present invention;

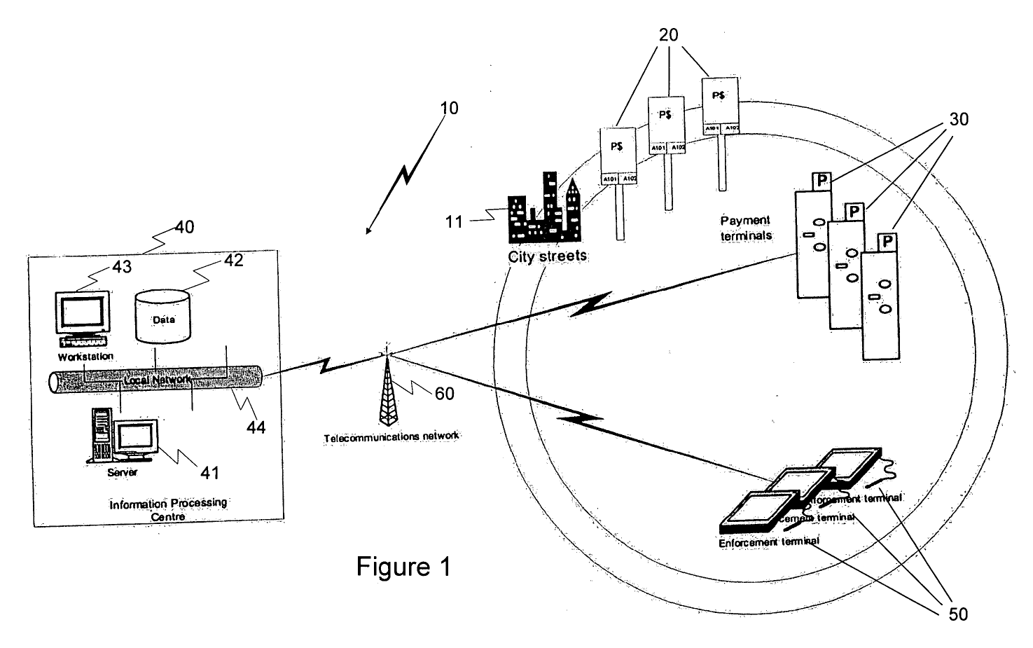

FIG. 2 illustrates an example of an information processing centre for the parking system;

FIG. 3 illustrates a CDMA/1xRTT wireless network card for communication within the parking system;

FIGS. 4a to 4e illustrate examples of handheld wireless devices for use as enforcement terminals; and

FIG. 5 shows data flow inside and between system components for the parking system.

### DETAILED DESCRIPTION OF THE INVENTION

The parking system 10 is a comprehensive system for the management and enforcement of parking spaces 20 within a city 11. The parking spaces 20 may be located on city streets or within parking lots or buildings. The system 10 includes a number of payment terminals 30, an information processing centre 40, enforcement terminals 50 for the use of enforcement officers and a telecommunication network 60.

Any number of parking spaces 20 may be part of the system, however, they would normally be arranged in groups in order to facilitate enforcement by an officer with a terminal 50.

The payment terminals 30, also known as pay by space machines, are strategically located near the parking spaces 20 to permit a client to pay for the parking time for the parking space 20 where his/her vehicle has been parked. However, the client need not select the payment terminal 30 closest to the parking space 20, since all terminals 30 in the system 10 can receive payment for all parking spaces in the system 10, and therefore the client may select the terminal 30 that is the most convenient for him/her.

As with all typical pay and display or pay by space machines, a client will interact with the terminal 30 for his/her parking requirements using a client interface such as a display screen and keypad or a touch screen facility. A server and software housed in the terminal 30 will control the operation of the terminal 30 and its communications via the network 60 with the information processing centre 40. In addition, terminal 30 has a coin slot with a coin discriminator and coin box as well as a card reader to facilitate payment for the parking space 20. A printer in terminal 30 will issue a receipt to the client for the parking time payment; the receipt need not be placed within the vehicle occupying the parking space 20, but may be saved by the client for further reference.

The information processing centre (IP Centre) 40 operates to manage the parking system 10 as a whole as well as the enforcement of the parking regulations. The information processing centre 40 includes a server 41, data storage 42, one or more work stations 43 and a local communication network 44 capable of communicating with the payment terminals 30 and enforcement terminals 50 through the network 60.

The information processing centre 40 will receive transactions and alarms from the payment terminal 30 in real time, and will respond to requests from the enforcement terminals 50 concerning the status of parking spaces 20. The transactions include revenue, audit and maintenance information of a properly operating terminal 30. This information is processed to prepare audits and reports, as well as to prepare the occupancy data required to update the enforcement terminals 50 in real time. The alarms or warnings may represent problems with a terminal 30 itself such as faulty equipment, with the communications network 60 or with the information processing centre 40.

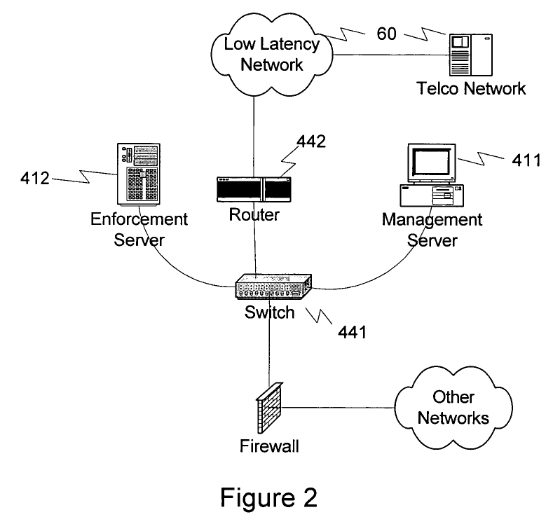

As illustrated in FIG. 2, the two main operations of the information processing centre 40, namely management and enforcement may be carried out by two separate and independent servers, the management server 411 and the enforcement server 412. These servers 411 and 412 are connected through a switcher 441 and a router 442 to the telecommunications network 60. The enforcement server 412 is connected to the telephone network 60 using a dedicated connection that will carry only traffic destined to the enforcement server 412 from the wireless network, or from the enforcement server 412 to the wireless network. A separate data path is provided for communications between the management server 411 and the payment terminal 30, without visibility to the enforcement server 412. Similarly, the enforcement server 412 will be isolated from management server 411 traffic by means of IP switch 441, preventing network load, from impacting the server's performance.

The management server 411 is devoted to such functions as rate profile management, collection audits, maintenance of historical data, credit card processing, machine and parking map configuration. The enforcement server 412 is devoted to providing online transaction processing required to maintain and to distribute timely and correct information on parking space occupancy and communication status. The enforcement server 412 responds to requests from the enforcement terminals 50 concerning the status of parking spaces and continuously updates the enforcement terminals 50 in real time with the status of the parking spaces being monitored by an enforcement officer.

The enforcement terminals 50 are used by enforcement officers to verify whether parking spaces are legally occupied and to issue violations for vehicles that are illegally parked. The enforcement terminal 50 includes a display and a keypad as well as a computer processor permitting the officer to interact with the terminal 50. A graphic image of the parking spaces 20 for which the officer is responsible is downloaded into the enforcement terminal 50 from the information processing centre 40, usually at night either by wireless communications or by direct wire to cut costs. When the officer is preparing to make his/her rounds, the enforcement terminal 50 will request occupancy data for the parking spaces 20 within the particular enforcement area. The enforcement server 412 will then send occupancy data to the enforcement terminal 50 indicating whether each specific parking space within the particular enforcement area is “paid” or “expired”. The officer will then use the terminal 50 to issue violations to the vehicles that are illegally parked.

For a street parking scenario, the graphical image on the Officers' terminal 50 contains the following information:

1. The name of the section of the street (the main street and the name of the two cross streets); and

2. The numbers of all the parking spaces located on the section of the street in their physical sequential order.

The graphics listed in 1 and 2 are loaded onto the terminal 50 from the information processing centre 40 prior to the terminal 50 being given to the enforcement officer.

3. A clear indication of every parking space for which the fee has not been paid at the time the data is sent from the IP Centre 40 at the request of the enforcement terminal 50; and

4. The time at which the IP Centre 40 generated the image.

The data for the graphics listed in 3 and 4 is sent to the enforcement terminal 50 either on request by the terminal 50, or periodically, such as every minute, to update the terminal 50 display. The occupancy graphics overlays the parking space graphics to provide a clear and complete picture to the enforcement officer.

The enforcement terminal 50 is a portable handheld computer providing an image of information for all parking spaces 20 on a single section of street or parking lot. A number of portable handheld devices generally meet the requirements for an enforcement terminal 50. The devices presented below fall into two general categories: small, portable, pen-based terminals with a touch screen, and few, if any keys, and large portable data terminals with a touch screen, but also with some or many keys for data entry and other functions. Each device has it own unique feature strengths and weaknesses, and some of the feature strengths are a result of compromise or in some cases weakness in other areas.

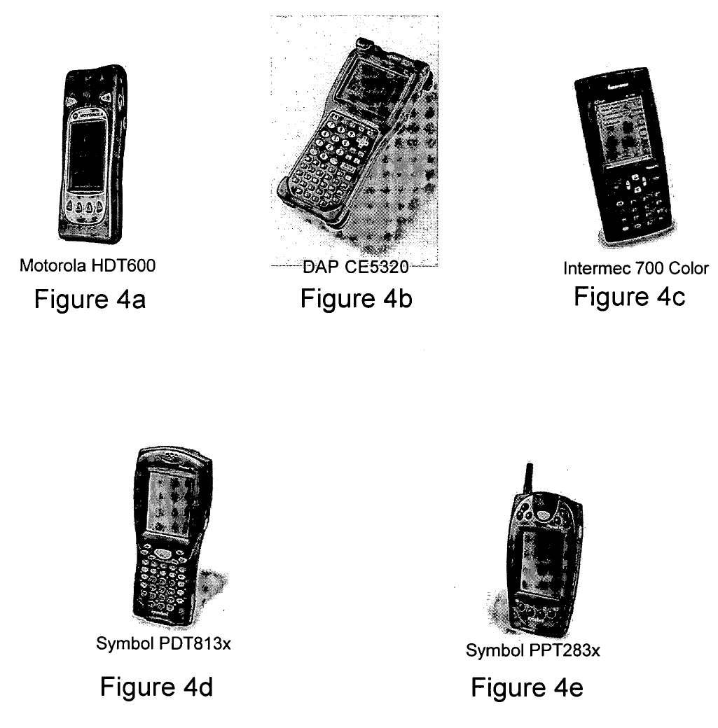

The devices shown in FIGS. 4a-4e support Microsoft® Windows® CE or Microsoft® Pocket PC operating systems, but also have an internal Type II PC expansion slot or can directly support an appropriate WWAN card suitable for the site. By choosing a Windows® based operating system, the system may be better positioned for introducing new applications, upgrades and increased capability in the future, however this invention is not bound to any one type of operating system.

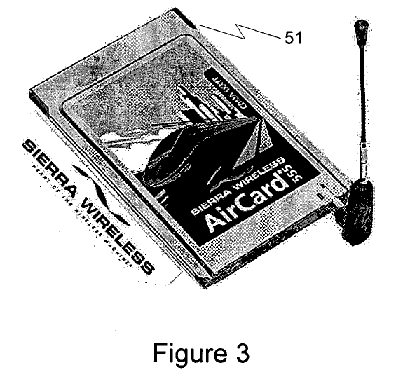

Also, based on the wireless connectivity solution, the device must be able to support a CDMA/1xRTT or similar based WWAN 51 shown in FIG. 3. While the CDMA/1xRTT WWAN connectivity technology is available today on some or all of the handheld devices shown in FIGS. 4a-4e, this invention is not bound to any one type of connectivity technology.

There are 5 devices shown in FIGS. 4a to 4e. All are considered ruggedized handhelds and all are industrial grade devices. The HDT600 is manufactured by Motorola—FIG. 4a, the CE5320 is from DAP—FIG. 4b, the 700 Color is from Intermec—FIG. 4c, while, the PPT283x and the PDT813x in FIGS. 4d and 4e are manufactured by Symbol.

The enforcement terminals 50 run an application, fundamental to this invention, whose primary function is to provide current on-street parking space occupancy data through a simple, easy to migrate, Graphical User-Interface (GUI). Data is passed to the enforcement terminals 50 equipped with radio cards through a wireless wide area service network 60 provided by the local telecom service provider. One type of telecommunications network that can be used is CDMA/1xRTT, however there are other choices available and being offered by the telecom service providers.

The enforcement officer periodically requests data to update the GUI, showing the particular space status for a street section. When the GUI decides to overlay parking occupancy information on top of displayed parking spaces 20, it requests occupancy information for every street section of which at least one parking spot is displayed on the screen. Thus, requests are very small. As the enforcement display is effectively required to display only 1 bit (paid/expired) for each parking spot, responses are similarly very small. An update request is anticipated to require no more than 32 bytes of data to be transferred, and a refresh of two parking sections fewer than 64 bytes. Total data usage for an enforcement terminal's 50 enforcement display updated 720 times per day, (1 request per minute in an 8 hour day), is estimated to be less than 1 MByte per month per enforcement terminal 50. As most telecom service providers of data services such as CDMA/1xRTT base their fee schedules on the amount of data transferred, a significant cost saving can be realized by utilizing the approach described in this invention.

Additional data will have to be exchanged for such purposes as authentication, key exchange, communication status determination, and other overheads. This is in the order of 10 percent of the enforcement display usage. While the above embodiment describes an enforcement terminal that utilizes a graphical user interface utilizing graphical street maps with overlaid parking data, the efficiencies and savings of the system described in this invention are still possible and evident with a simpler user interface that utilizes scroll down lists of parking spaces by area/geographic location, with the status of each shown.

The system 10 uses leading edge network technology such as developed by the industry leaders in the telecommunications industry and deployed by leading service providers. Each of the payment terminals 30 and enforcement terminals 50 is fitted with CDMA/1xRTT or similar radio card or radio modem. Applications and connectivity modules allow the data to be transferred across this CDMA/1xRTT network.

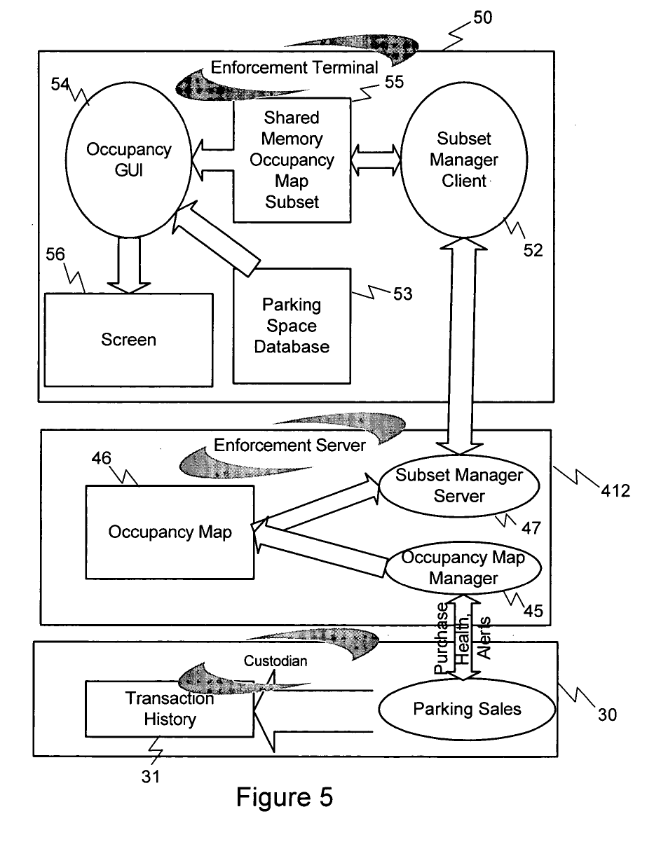

Data will flow to/from three main system components, the payment terminals 30, the enforcement server 412, and the enforcement terminals 50. FIG. 5 shows the data flow between and inside each of these system components.

The payment terminal 30 maintains a transaction history 31 and transfers transaction data to the occupancy map manager 45 in the enforcement server 412.

The enforcement server 412 includes a major data store for the occupancy map 46. This map records information on each parking space (time/expiry of sale for every concurrent purchase, receipt ids, etc) needed to support current and future purchase interface features, as well as the current enforcement requirements. A subset of this data is made available to the subset manager 52 of each enforcement terminal 50 via the subset manager 47.

The enforcement terminals 50 contain two major data stores, the parking space database 53 and the occupancy map subset memory 55. The parking space database 53 encodes a map or a graphical representation of all parking spaces configured to be managed by the system 10. This database changes little over time, and will be refreshed as necessary when the enforcement terminal 50 is connected to a “wired” communications adaptor. This is typically performed on a nightly basis. The parking space database 53 groups parking spaces into street sections of up to 64 connected spaces. The GUI 54 can display a map of parking spaces 20 on the screen 56 including one or more street sections obtained from the parking space database 53 with an overlay of the occupancy of the spaces 20 received from memory 55. Each street section includes information such as street name, identities of connected street sections, parking space numbers, and non-parking space objects useful for orienting the enforcement officer with his/her surroundings, and therefore permits the enforcement officer to verify whether vehicles are legally or illegally parked.

Since the occupancy map of itself represents very little data, the communication cost for frequently updating the enforcement terminals 50 in real time will be very low, which permits the enforcement officers to carry out their verifications with a very low error rate.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. Parking system comprising:
one or more payment terminals for receiving payment for parking spaces;
an information processing centre for receiving transaction and alarm information from the payment terminals;
one or more enforcement terminals for storing identification information for selected parking spaces and for periodically receiving occupancy data for the selected parking spaces from the information processing centre for displaying a map of the parking spaces with occupancy indication; and
a two-way telecommunications network for transmitting information in real time between the information processing centre and the payment and the enforcement terminals.

2. A system as claimed in claim 1 wherein the information processing centre includes a management server and an enforcement server.

3. A system as claimed in claim 1 wherein the enforcement terminals include means for displaying the identification information for the parking spaces as graphic information.

4. A system as claimed in claim 3 wherein the graphic information includes:
street location of the parking spaces; and
parking space location numbers.

5. A system as claimed in claim 4 wherein street location information includes street name, connecting streets and landmarks.

6. A system as claimed in claim 4 wherein the parking space occupancy data is overlaid on the parking space location numbers to indicate occupancy.

7. A system as claimed in claim 6 wherein the parking space occupancy indication depicts whether the parking space is “paid” or “expired”.

8. A method of operating a parking system having one or more payment terminals for parking spaces and one or more enforcement terminals comprising:
storing identification information of selected parking spaces in the enforcement terminals;
receiving transaction information from the payment terminals;
processing the transaction information;
periodically transferring real time space occupancy data regarding the selected parking spaces to the enforcement terminals;
displaying the selected parking space information and the occupancy data on the enforcement terminal to provide an indication whether each selected parking space is “paid” or “expired”.

9. A method as claimed in claim 8, which further includes:
receiving alarm information from the payment terminals; and
processing the alarm information to manage the parking system.

10. A method of enforcing a parking system having one or more payment terminals for parking spaces and one or more enforcement terminals comprising:
storing identification information of selected parking spaces in the enforcement terminals;
receiving transaction information from the payment terminals;
processing the transaction information to provide parking space occupancy data;
transferring real time space occupancy data regarding the selected parking spaces to the enforcement terminals;
displaying the selected parking space information and the occupancy data on the enforcement terminal to provide an indication whether each selected parking space is “paid” or “expired”.

11. A method as claimed in claim 10, which includes transferring the space occupancy data regarding the selected parking spaces to the enforcement terminals periodically.

12. A method as claimed in claim 10, which includes transferring the space occupancy data regarding the selected parking spaces to the enforcement terminals when requested by the enforcement terminal.

13. A parking enforcement system for a parking system having one or more payment terminals for receiving payment for parking spaces comprising:
an enforcement server for receiving transaction information from the payment terminals and for generating occupancy data for the parking spaces in real time; and
one or more enforcement terminals for storing identification information for selected parking spaces and for receiving occupancy data for the selected parking spaces from the enforcement server for displaying a map of the parking spaces with an indication of occupancy.

14. A parking enforcement system as claimed in claim 13 wherein the enforcement terminal receives the occupancy data periodically.

15. A parking enforcement system as claimed in claim 13 wherein the enforcement terminal receives the occupancy data on demand.

16. An enforcement system as claimed in claim 13 wherein the enforcement terminals include means for displaying the identification information for the parking spaces as graphic information.

17. An enforcement system as claimed in claim 16 wherein the graphic information includes:
street location having street name, connecting streets and landmarks of the parking spaces; and
parking space location numbers.

18. An enforcement system as claimed in claim 16, which includes means for overlaying the occupancy data on the parking space location numbers to indicate occupancy.
